(19) United States
(12) Patent Application Publication
(10) Pub. No.: US 2024/0383160 A1
(43) Pub. Date: Nov. 21, 2024

(54) REMOTELY CONTROLLED CONNECTION OF UMBILICAL CABLE WITH A ROBOT FOR INTERVENTIONS IN DUCTS

(71) Applicants: PETRÓLEO BRASILEIRO S.A. - PETROBRAS, Rio de Janeiro (BR); SERVIÇO NACIONAL DE APRENDIZAGEM INDUSTRIAL DEPARTAMENTO REGIONAL DE SANTA CATARINA - SENAI/SC, Florianopolis (BR)

(72) Inventors: André Viegas WENTZ, Porto Alegre (BR); Augusto Parigot DE SOUZA, Florianopolis (BR); Frederico EGGERS, Porto Alegre (BR); Anselmo Luis da Silva JUNIOR, Florianopolis (BR); Lucas Bianco Garcia DA SILVA, Porto Alegre (BR); Hugo Francisco Lisboa SANTOS, Rio de Janeiro (BR)

(73) Assignees: PETRÓLEO BRASILEIRO S.A. - PETROBRAS, Rio de Janeiro (BR); SERVIÇO NACIONAL DE APRENDIZAGEM INDUSTRIAL DEPARTAMENTO REGIONAL DE SANTA CATARINA - SENAI/SC, Florianopolis (BR)

(21) Appl. No.: 18/691,586

(22) PCT Filed: Sep. 30, 2022
(86) PCT No.: PCT/BR2022/050386

§ 371 Date: Mar. 13, 2024

(30) Foreign Application Priority Data
Oct. 1, 2021 (BR) 1020210198281

(51) Int. Cl. B25J 19/00; B25J 11/00

(52) U.S. Cl. CPC B25J 19/0025; B25J 11/00; B25J 19/0075

(57) ABSTRACT

The present invention proposes a connection structure for a robot that operates inside pipes, as its small size allows high tractions in restricted spaces. It can be applied to form the connection structure of intervention robotic systems that operate under traction and can also be used to connect two umbilicals without using a large volume connector. Accordingly, the solution found by the present application solves the connection problems between two systems, the robot and the umbilical cable, and solves the problem of the state of the art, using a splice housing (1) that internally contains a splice hood (5).

### FIELD OF THE INVENTION

The present invention is based on the development of a solution for a connection structure for equipment that operates within pipes.

### DESCRIPTION OF THE STATE OF THE ART

For the operation of a remotely controlled robotic system, the communication with the surface is necessary, today commonly carried out via an umbilical cable. To do this, it is necessary to connect this robot with its umbilical cable, permanently or not.

Due to the high traction of the robotic system to pull the umbilical cable, it is necessary for the structures to consume excessive space to resist the mechanical stresses, which makes the application in restricted diameter pipes difficult, since internal space is required to carry out connections and/or cable routing.

In flexible pipes, it is necessary for the robot to make curves, and these curves can have bending radii as small as five times the diameter of the pipe (5D); so, the solution must be small and accept curvatures of this type.

The operation of the robot can take place in an environment containing oil and corrosive fluids; therefore, it is necessary to protect the cables coming from the inside of the umbilical when the coating thereof ends and there occurs the termination of the same.

Document CN209241285U discloses a utility model that aims at forming a structure for locking and controlling umbilicals in a subsea robot. The structure has the advantages of being simple, providing a small space for the umbilical, fixing and protecting the umbilical from damages. Despite presenting connection means for umbilicals, the document is not capable of performing curves with radii as small as five times the diameter of the pipe (5D).

Document CN108177743A discloses a bullet-type device for connecting between an umbilical and an ROV. It allows greater flexibility in rotating the ROV underwater, reducing the need for electrical insulation, avoiding cracks caused by torsion. Despite presenting connection means for umbilicals, the document is not capable of performing curves with radii as small as five times the diameter of the pipe (5D).

Document U.S. Pat. No. 7,906,727B2 discloses a bullet-type connector for umbilicals, and a method of disconnecting an umbilical from a bullet-type connector. The bullet connector described herein comprises a tapered nose cone, a body comprising a cylindrical housing, a cylinder removably mounted to the cylindrical housing, and a locking plate removably fixed to the lower region of the cylinder. Despite presenting connection means for umbilicals, the document is not capable of performing curves with radii as small as five times the diameter of the pipe (5D).

In view of the difficulties present in the state of the art as mentioned above, and for solutions for connecting umbilical cables with robots in pipes with curves of radii as small as five times the diameter of the pipe (5D), the need arises to develop a technology capable of performing effectively and in accordance with current environmental guidelines. The above-mentioned state of the art does not have the unique features that will be presented in detail below.

### Objective of the Invention

It is an objective of the invention to obtain equipment capable of enabling and simplifying the connection of umbilical cables with robots in confined environments with reduced dimensions and the need of making curves with radii of five times the diameter.

### BRIEF DESCRIPTION OF THE INVENTION

In order to achieve the objectives as described above, the present invention proposes a connection structure for a robot that operates inside pipes, as its small size allows high tractions in restricted spaces. It can be applied to form the connection structure of intervention robotic systems that operate under traction. It can also be used to connect two umbilicals without using a large volume connector.

There is an umbilical cable connection with robot characterized by making the connection between two systems, at least one splice housing (1) and at least one splice hood (5).

### BRIEF DESCRIPTION OF THE DRAWINGS

The present invention will be described in more detail below, with reference to the attached figures that, in a schematic and not limiting way regarding the inventive scope, represent examples of embodiment thereof. In the drawings, there can be seen:

FIG. 1 illustrates a section of the splice housing solution;

FIG. 2 illustrates a sectional view of the splice hood solution inside the splice housing;

FIG. 3 illustrates the connection with the umbilical on the left and the connection with the robot on the right;

FIG. 4 illustrates the assembly of the gripping system, images without the anchorage of the umbilical aramid sleeve;

FIG. 5 illustrates the assembled splice hood;

FIG. 6 illustrates the assembly of the connection solution.

### DETAILED DESCRIPTION OF THE INVENTION

There follows below a detailed description of a preferred embodiment of the present invention, which is exemplary and in no way limiting. Nevertheless, it will be clear to a technician skilled on the subject, from reading this description, possible additional embodiments of the present invention further comprised by the essential and optional features below.

Before the present invention, the solutions had a metal casing and were therefore too large and could not be applied inside pipes. In state-of-the-art connectors, it is not possible to butt connect hydraulic or high current lines, in addition to the dimensions in relation to the few connectors available, making their use within flexible pipes unfeasible.

By consuming space in the longitudinal direction, the present invention does not require space in the diameter of the section for the connectors between the umbilical and the robot to be spliced. The springs covered by the fiber sleeve physically protect the components and transmit mechanical traction between the robot and the umbilical cable. The rubber hood inside the spring creates a tight compartment protecting the connectors from the aggressive environment; in this way, several items can be connected along the splice hood and further perform the 5D curves (curvature radius equal to 5× the riser diameter) found in flexible pipes.

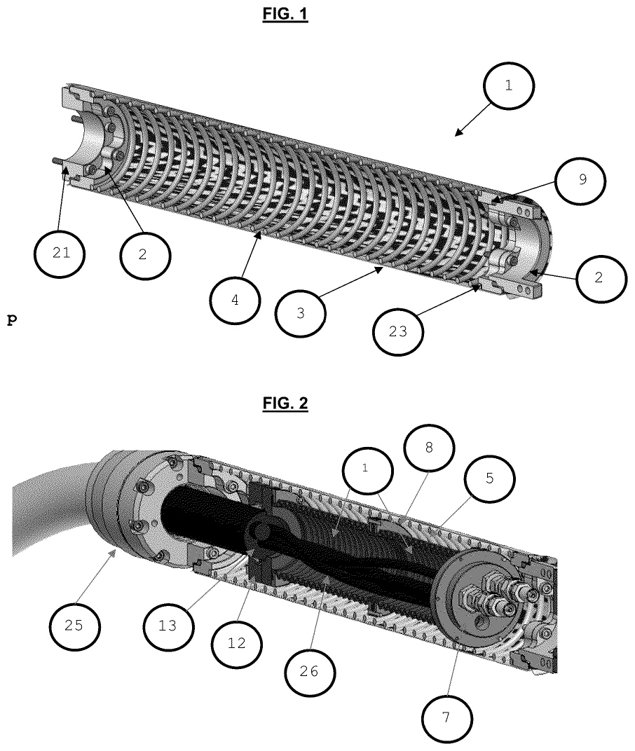

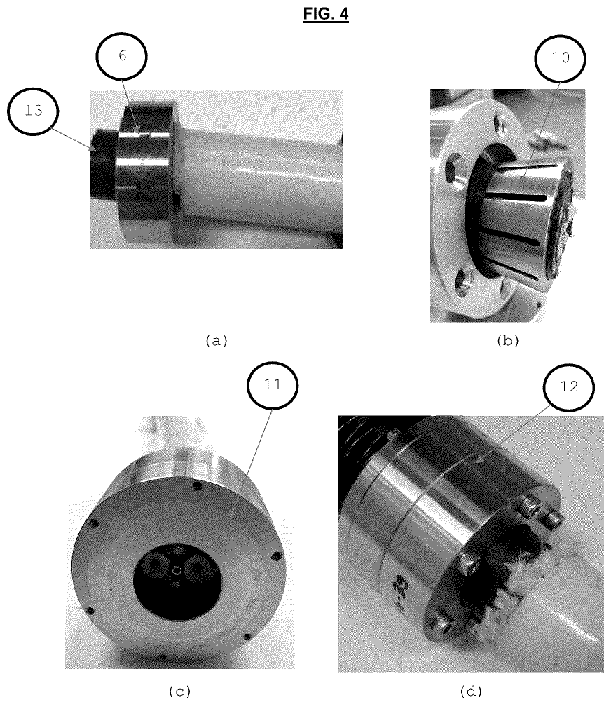

The solution found by the present application solves the connection problems between two systems, the robot and the umbilical cable. It solves the problem of the state of the art by using a splice housing (1) that contains a splice hood (5). The splice housing, as shown in FIG. 1, consisting of two inverted anchorages (2), being the screwed assembly of components 21 and 22 and the screwed assemblies of 23 and 24, wherein each set is part of the anchorage of the aramid sleeve, separated by a spring (4), mechanically interconnects the umbilical with the robot, transmitting traction through the aramid sleeve (3), which allows a high flexibility to perform curves. The anchorages are characterized by having a housing for an anchorage ring (9) through which the fabric is looped. Its connections are fixed by using screws. In the case of the prototype robot, it is joined to the robot by screws under shear and to the umbilical by screws under tension, as shown in FIG. 4.

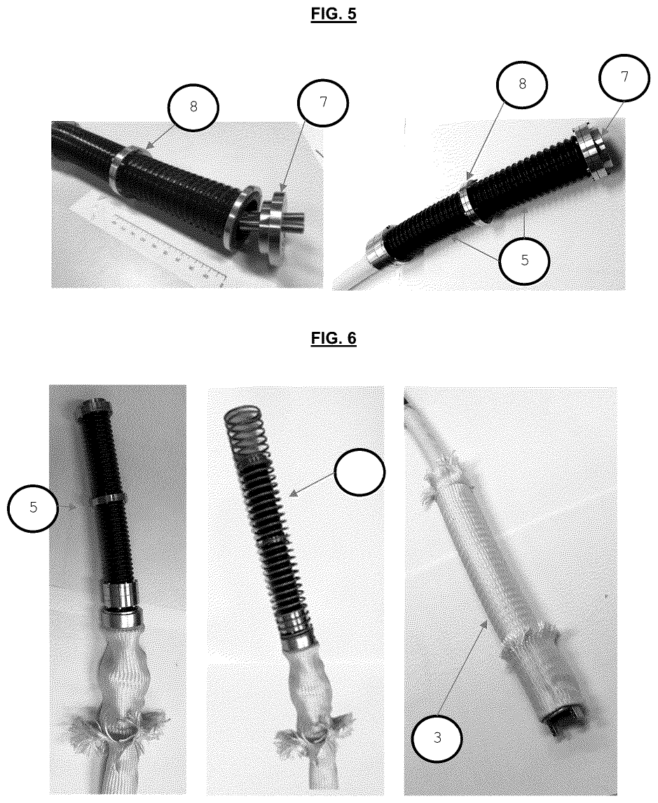

The splice hood (5), seen in section in FIG. 2, protects the exposed cables of the umbilical (pig-tails), anchoring itself to the exposed polymer of the umbilical cable (13) through the gripping system (12) (FIG. 4d). In a preferred embodiment of the invention, the splice hood (5) has two corrugated hoods (15) in its design (there can be as many as necessary), joined by a transition flange (8), FIG. 5. Finally, the cover of the splice hood serves as an interface for the connectors that will be crimped onto the exposed cables. The item 25, in FIG. 2, is a traditional umbilical connector, which receives the set of inverted anchorages (2), directly mechanically connected to the components (21) and (22), also by screwing. The umbilical cables (26) can be hydraulic hoses, electrical cables or a fiber optic conduit. The cover (7) of the splice hood (5) is where the connectors that lead the umbilical cable connections (26) out of this protective environment are located.

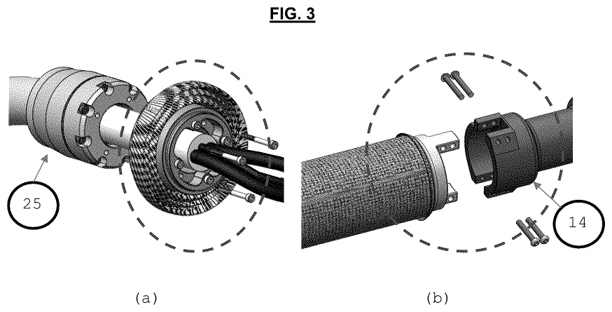

FIG. 3a illustrates an assembly step where the aramid sleeve is anchored to part 21 only, allowing access to the screws that secure this anchorage to the connector (25) of the umbilical cable where these screws are under tension. FIG. 3b illustrates the last step of assembly, when the splice housing is connected to the robot load cell (14) by screws under shear. FIG. 4a and FIG. 4b present the steps for assembling the gripping system, respectively first inserting the interface cover (6) with the umbilical (13), then the grip (10) and, finally, the closing stop (11) (FIG. 4c), screwing the entire system together. The grip (10) is a wedge that produces a force to fix the umbilical cable (13), to prevent slipping.

The assembled splice hood (5) can be seen in FIG. 5 and the complete solution with the splice housing (1) in FIG. 6. In FIG. 6a, the splice hood (5) is assembled. In FIG. 6b, there can be seen the spring (4) introduced over the splice hood. In FIG. 6c, there can be seen the aramid sleeve (3) covering the spring (4). The assembly emphasizes that it is possible to make electrical, hydraulic and mechanical connections in a reduced space compared to previous technology solutions.

1. An umbilical cable connection with robot, characterized in that it makes the connection between two systems, at least one splice housing and at least one splice hood.

2. The connection according to claim 1, characterized in that the splice housing comprises at least two inverted anchorages separated by a spring, covered by an aramid sleeve, with which the assembly mechanically interconnects the umbilical (13) with the robot.

3. The connection according to claim 1, characterized in that the splice hood comprises at least one splice hood cover, at least one gripping system with the umbilical and at least one corrugated hood.

4. The connection according to claim 2, characterized in that the splice housing is fixed by screws under shear with the robot and screws under tension in the umbilical.

5. The connection according to claim 3, characterized in that the corrugated hood is anchored to the exposed polymer of the umbilical cable through the gripping system using the wedge.

6. The connection according to claim 3, characterized in that the splice hood alternatively comprises two corrugated hoods joined by a transition flange.
